(19) United States
(12) Patent Application Publication
(10) Pub. No.: US 2015/0332240 A1
(43) Pub. Date: Nov. 19, 2015

(54) APPARATUS, SYSTEM AND METHOD FOR BEACON-ENABLED MOBILE POS

(71) Applicant: MOZIDO, INC., Austin, TX (US)

(72) Inventors: Teri Harwood, Austin, TX (US); Minaz Sarangi, Ontario (CA); Aliaksandr Manusovich, Austin, TX (US); Steve Bacastow, Cumming, GA (US)

(21) Appl. No.: 14/711,622

(22) Filed: May 13, 2015

Related U.S. Application Data
(60) Provisional application No. 61/994,598, filed on May 16, 2014.

(51) Int. Cl. G06Q 20/20; G06Q 20/32; G07G 1/00; G07G 1/01; G07G 1/14

(52) U.S. Cl. CPC G06Q 20/202; G07G 1/01; G07G 1/14; G07G 1/0036; G06Q 20/327; G06Q 20/3224

(57) ABSTRACT

A system, method and apparatus for that allow participating consumers and businesses to initiate and fulfill payment transactions using mobile devices based on their physical proximity to one another using an apparatus equipped with the capability to both send and receive beacon signals.

### CROSS REFERENCE TO RELATED APPLICATIONS

This application claims priority to and the benefit of U.S. Provisional Patent Application Ser. No. 61/994,598, entitled “Apparatus, System and Method for Beacon-Enabled Mobile POS”, filed on May 16, 2014, which application is incorporated by reference herein in its entirety.

### BACKGROUND

There has been a significant increase in the use of mobile devices for payment transactions. These payment transactions may be person-to-person, person-to-business, or business-to-business. Consumers have demonstrated a propensity to use their mobile devices to initiate payment transactions with merchants; however, many merchants lack the ability to accept a payment from a mobile device. Also, there can be a significant cost related to upgrading legacy point of sale (POS) equipment for the purpose of accepting payments from mobile devices.

### BRIEF SUMMARY

Embodiments described herein provide systems, methods and apparatuses that allow individuals to pay merchants using their mobile devices without requiring the merchants to invest significantly in new equipment or to modify the legacy POS infrastructure. Embodiments further allow participating consumers and businesses to initiate and fulfill payment transactions using mobile devices based on their physical proximity to one another using an apparatus equipped with the capability to both send and receive Bluetooth Low Energy (BLE) beacon signals.

In a general embodiment, a system can be configured to allow a consumer to identify and pay a merchant in a transaction using a mobile device in communication with an apparatus and remote computing services. In one embodiment, mobile device consumers can use a mobile device in communication with a local apparatus and remote ‘cloud’ computing service to identify a merchant from a list of registered merchants. Having identified the correct merchant, the user can initiate a transfer of financial value from a linked payment account to a designated account owned by the merchant. A confirmation of the successful payment is delivered to the local apparatus and to the consumer's mobile device.

In one embodiment, a point of sale (POS) device is provided which includes a processor, a beacon configured to receive data from and transmit data to one or more mobile computing systems, and a payment coordinating module configured to implement the beacon to perform the following: transmit identification data from the beacon indicating the relative location of the beacon and further indicating that the beacon is associated with a specified entity, receive transaction information from a mobile device including information identifying a customer and a payment amount, transmit the received transaction information to a payment processing system, receive an indication from the payment processing system that the payment was processed and transmit a confirmation notification to the mobile device indicating that the transaction was processed.

In another embodiment, a computer system performs a method for conducting a monetary transaction using a beacon. The computer system receives identification data from a beacon indicating the relative location of the beacon and an indication of association with a specified entity. The computer system presents a transaction indication to a user indicating that a transaction is being conducted with the entity and receives input from the user indicating that the transaction is to be completed. The computer system further transmits transaction information to the beacon, where the beacon is configured to transmit the transaction information to a POS device and/or a payment processing service. The computer system also receives a confirmation notification indicating that the transaction was processed and presents the confirmation notification to the user on the mobile device.

Accordingly, an apparatus, system and method are provided herein for proximity payments between a consumer and merchant without significant investment in new POS technology. Described embodiments may be used independently or combined together.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates components and participants in an embodiment of a beacon-enabled POS.

FIG. 2 illustrates an embodiment of an in-store cashier (POS) device and its components.

FIG. 3 illustrates an embodiment of a sequence of steps performed to identify and pay a merchant using a beacon.

FIG. 4 illustrates a computer architecture in which embodiments described herein may operate including conducting a monetary transaction using a beacon.

FIG. 5 illustrates a flowchart of an example method for conducting a monetary transaction using a beacon from the perspective of the beacon.

FIG. 6 illustrates a flowchart of an example method for conducting a monetary transaction using a beacon from the perspective of a mobile device.

### DETAILED DESCRIPTION

Embodiments described herein provide systems, methods and apparatuses that allow individuals to pay merchants using their mobile devices without requiring the merchants to invest significantly in new equipment or to modify the legacy POS infrastructure. Embodiments further allow participating consumers and businesses to initiate and fulfill payment transactions using mobile devices based on their physical proximity to one another using an apparatus equipped with the capability to both send and receive Bluetooth Low Energy (BLE) beacon signals.

In a general embodiment, a system can be configured to allow a consumer to identify and pay a merchant in a transaction using a mobile device in communication with an apparatus and remote computing services. In one embodiment, mobile device consumers can use a mobile device in communication with a local apparatus and remote ‘cloud’ computing service to identify a merchant from a list of registered merchants. Having identified the correct merchant, the user can initiate a transfer of financial value from a linked payment account to a designated account owned by the merchant. A confirmation of the successful payment is delivered to the local apparatus and to the consumer's mobile device.

In one embodiment, a point of sale (POS) device is provided which includes a processor, a beacon configured to receive data from and transmit data to one or more mobile computing systems, and a payment coordinating module configured to implement the beacon to perform the following: transmit identification data from the beacon indicating the relative location of the beacon and further indicating that the beacon is associated with a specified entity, receive transaction information from a mobile device including information identifying a customer and a payment amount, transmit the received transaction information to a payment processing system, receive an indication from the payment processing system that the payment was processed and transmit a confirmation notification to the mobile device indicating that the transaction was processed.

In another embodiment, a computer system performs a method for conducting a monetary transaction using a beacon. The computer system receives identification data from a beacon indicating the relative location of the beacon and an indication of association with a specified entity. The computer system presents a transaction indication to a user indicating that a transaction is being conducted with the entity and receives input from the user indicating that the transaction is to be completed. The computer system further transmits transaction information to the beacon, where the beacon is configured to transmit the transaction information to a POS device and/or a payment processing service. The computer system also receives a confirmation notification indicating that the transaction was processed and presents the confirmation notification to the user on the mobile device.

The following discussion refers to an apparatus and a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

As described herein, a computing system may include at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network. Such communication channels may include hardware-based receivers, transmitters or transceivers, which are configured to receive data, transmit data or perform both.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments described herein also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, embodiments described herein may comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

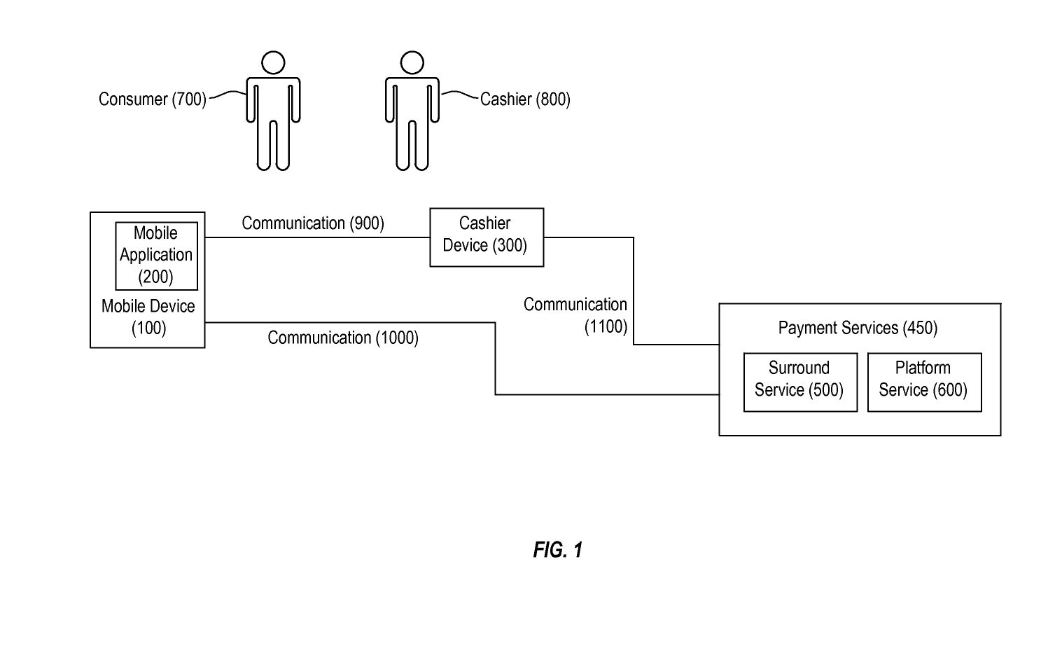

FIG. 1 shows an embodiment of a computing architecture or ecosystem that supports a beacon-enabled point of sale (POS). The beacon-enabled POS allows customers to purchase items or perform other transactions using their mobile devices (e.g. smart phones, tablets, laptops, wearable devices, etc.). The ecosystem includes a customer 700 and a cashier 800. The customer 700 and cashier 800 may be at any type of retail establishment including a store, a restaurant, a theater, a resort or any other place where a point of sale may be located. The consumer 700 may use mobile device 100 to communicate with the cashier's device 300. The cashier's device 300 may be a point of sale that includes a beacon, or may simply be a beacon with which the user's mobile device communicates. For instance, the user's mobile device 100 may communicate with a beacon through communication 900 and the beacon may communicate with the payment services 400.

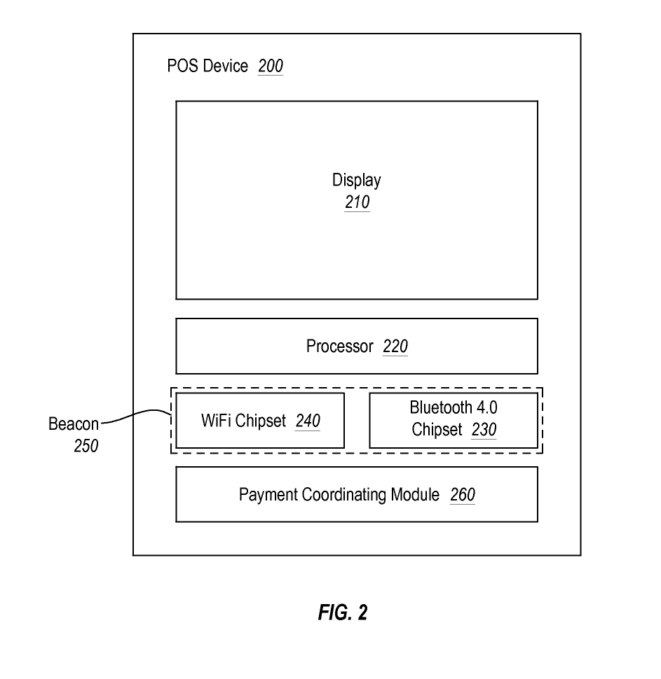

As shown in FIG. 2, a cashier's device may include multiple different hardware, firmware and/or software components. For instance, the cashier's device (i.e. POS device 200) may include a display 210 for displaying transaction information, a processor 220 such as an ARM- or X86-based processor, a beacon 250 with various communication means including a WiFi chipset 240 and/or a Bluetooth chipset (e.g. Bluetooth 4.0 chipset 230), and a payment coordinating module 260. Other communication means may include wired connections such as Ethernet, or wireless connections such as code division multiple access (CDMA) or other cellular connections. The various communication means may be used to communicate with the mobile device 100 of FIG. 1 and/or with other systems including payment services 400.

In some embodiments, the Bluetooth chipset 230 may be part of or may itself comprise the hardware beacon 250. The beacon 250 may transmit messages notifying the surrounding mobile devices (e.g. 100) that they are at a specified geographic location, or are in a specified store, or at a given event venue. The customer's mobile device may, for example, receive an indication from a low-energy Bluetooth beacon indicating the location of the beacon and the user's proximity to the beacon. The beacon itself may be attached to or otherwise part of the cashier device 200.

Returning to FIG. 1, the cashier device 300 may receive a communication 900 from the customer's mobile device 100 indicating that a transaction has been approved. The cashier device 300 may then communicate (in communication 1100) with one or more payment services 400 including a surround service 500 and/or a platform service 600. These payment services 400 may be configured to conduct a transaction directly, transferring value from the customer 700 to the merchant via the cashier 800. Alternatively, the payment services 400 may cause the transaction to be carried out via other payment entities or services.

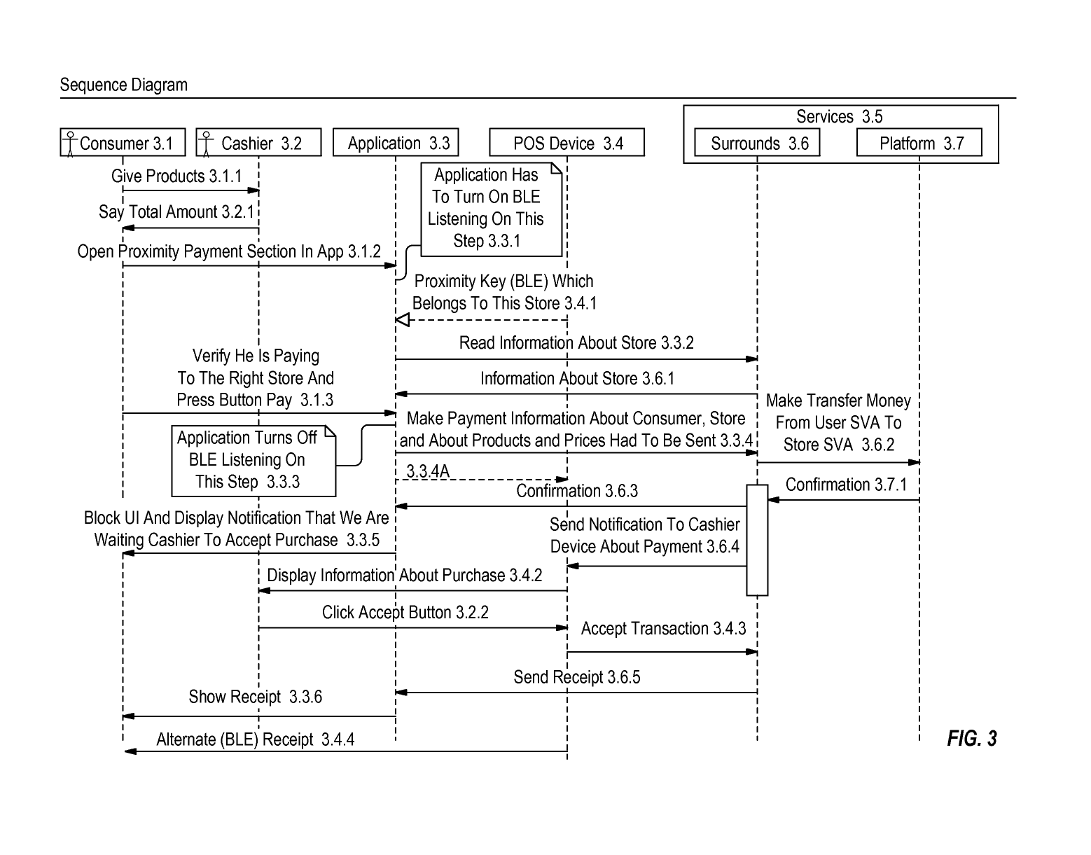

Accordingly, mobile device 100 may use communication 900 to indicate to the cashier device 300 that a transaction has been approved. The cashier device 300 may then send a communication 1100 to one or more of the payment services 400 to conduct the transaction. The payment services 400 may then send a communication 1000 to the cashier's device 300 and/or to the mobile device 100 indicating that the transaction has been completed or has failed. This process will be described in greater detail below with regard to FIG. 3.

FIG. 3 illustrates a series of steps between a consumer (3.1), cashier (3.2), a mobile payment application (3.3), a cashier device (3.4), one or more payment services (3.5) including a surround service (3.6) and a platform service (3.7). In step 3.3.1 the consumer (3.1) notifies the cashier (3.2) of the products, services, admission prices, etc. that they wish to pay for. In step 3.3.2, the cashier (3.2) informs the consumer of the total amount due. In step 3.1.2, the consumer opens the mobile payment application (3.3) (e.g. a mobile wallet application), and a proximity payment section is either opened automatically or the user opens it manually.

In step 3.3.1, the mobile payment application (3.3) turns on an antenna or beacon such as a Bluetooth Low-Energy (BLE) antenna within the mobile device 100. In step 3.4.1, the mobile payment application (3.3) listens to BLE signals transmitted from the beacon of the cashier device (3.4). Such signals may contain data that uniquely identifies the merchant (or location) the user is currently at. In step 3.3.2, the mobile payment application (3.3) uses the data obtained from the cashier device (3.4) to obtain merchant information from the surround service (3.6). This information about the merchant is sent back to the mobile payment application (3.3) in step 3.6.1.

In step 3.1.3, the consumer (3.1) verifies the merchant information, enters the tender amount, and initiates the payment. At this point, having initiated the payment, the mobile payment application (3.3) may automatically turn off the BLE antenna as illustrated in step 3.3.3. In step 3.3.4, the mobile payment application (3.3) sends the tender amount to the surround service (3.6). This transaction may also include a transaction sequence number, a unique device ID and/or a device token. Alternatively, the mobile payment application (3.3) may send the tender amount, and a transaction sequence number, a unique device ID and/or a device token to the cashier device (3.4) in step 3.3.4A. In step 3.6.2, the surround service (3.6) initiates a transfer of value request to the platform service (3.7). The platform service (3.7), having thus transferred the value from the consumer's selected or default account to the account associated with this merchant, sends a confirmation message in step 3.7.1 back to the surround service (3.6).

In step 3.6.3, the surround service (3.6) sends a confirmation message back to the mobile payment application (3.3). The confirmation message may also contain a transaction sequence number, a unique device ID and/or a device token. The cashier device (3.4) can be configured to compare the transaction sequence number, the unique device ID and/or device token received from the surround services (3.6) to the transaction sequence number, unique device ID and/or device token received from the mobile payment application (3.3).

In step 3.3.5, the mobile payment application (3.3), having received the confirmation message, displays an appropriate message to the consumer. In step 3.6.4, the surround service (3.6), sends a notification to the cashier device (3.4), indicating that the transfer of value has been completed. In step 3.4.2, the cashier (3.2), views the payment confirmation message. In step 3.2.2, the cashier (3.2) accepts the payment from the consumer (3.1) by pressing the accept button on the cashier device (3.4). In step 3.4.3, the cashier device notifies the surround service (3.6) that the payment has been accepted. In step 3.6.5, the surround service (3.6) sends a confirmation receipt to the mobile payment application (3.3). The process is completed in step 3.3.6, when the consumer (3.1) views the receipt as displayed by the mobile payment application (3.3). Alternatively, a receipt may be transmitted (e.g. via BLE) from the cashier device 3.4 to the consumer 3.1 in step 3.4.4.

In one embodiment, a POS device may be provided that includes a beacon configured to receive data from and transmit data to one or more mobile computing systems (such as phones, tablets, laptops, wearable devices or other computing systems). The data provides information about the location of the POS and may further include an indication of the establishment in which the POS device is located. The POS device may further include a payment coordinating module that receives transaction information from a mobile payment application, where the transaction information includes information identifying a customer, sends the transaction information received from the mobile payment application in combination with POS-generated transaction information to a payment processing entity, receives an indication that the payment was processed, and causes the beacon to transmit a notification notifying the identified customer that the transaction was processed.

The POS device may be configured to receive payments in a variety of forms including debit card, credit card or from a mobile device. The POS device may be configured to communicate with mobile devices using WiFi, Bluetooth or via another wireless standard. In some cases, the POS device is Europay Mastercard Visa (EMV) compatible. As such, the EMV-compatible device may access and receive payments from chip cards, which provide an additional level of security over conventional credit cards. In some embodiments, Bluetooth or other hardware beacons may be incorporated into or added on to existing POS devices. This enables the POS devices to communicate directly with other mobile computing devices. In cases where the beacon is a Bluetooth beacon, the Bluetooth beacon communicates with the mobile computing systems using the Bluetooth wireless communication standard (currently version 4.0).

In another embodiment, a method is provided for conducting a monetary transaction (or other transaction of value) using a beacon. The method includes receiving data from a beacon indicating the relative location of the beacon and an indication of its association with an entity (such as a store or other establishment). The method further includes presenting an indication to a user indicating that a transaction is being conducted with the entity, receiving input from the user indicating that the transaction is to be completed, and transmitting the transaction information to a point of sale (POS) device and/or a payment processing service.

The method may also include receiving a confirmation notification indicating that the transaction was processed, and presenting the confirmation notification to the user. The confirmation notification includes a transaction receipt listing the goods or services that were purchased during the transaction. Thus, in this manner, a transaction may be carried out by communicating with a beacon (such as Bluetooth Low-Energy beacon) attached to or integrated within a POS device. The transaction may be processed by payment services or entities, and may be initiated and finalized using beacon messages transmitted and received by a two-way beacon.

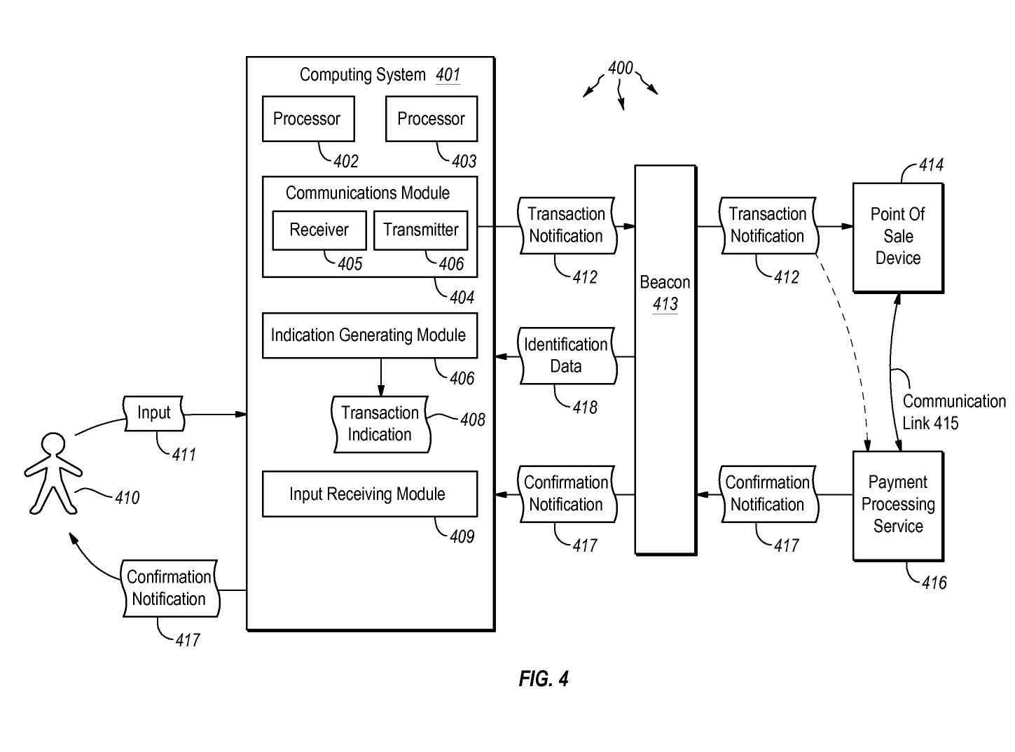

FIG. 4 illustrates a computer architecture 400 in which at least one embodiment may be employed. Computer architecture 400 includes computer system 401. Computer system 401 may be any type of local or distributed computer system, including a cloud computing system. The computer system 401 includes modules for performing a variety of different functions. For instance, the communications module 404 may be configured to communicate with other computing systems. The communications module 404 may include any wired or wireless communication means that can receive and/or transmit data to or from other computing systems. The communications module 404 may be configured to interact with databases, mobile computing devices (such as mobile phones or tablets), embedded or other types of computing systems.

The computer system 401 may also include an indication generating module 407. The indication generating module 407 may generate transaction indication 408 which is presented to user 410. The transaction indication may include details about a pending transaction including the merchant's name, the bank, credit or other account that will be used to conduct the transaction, and any other associated information. The user may view the transaction indication 408 and approve or deny the transaction. As shown in FIG. 4, the user 410 may provide input 411 to the input receiving module 409 which approves or denies the transaction. If the user approves the transaction the transaction may be carried out using transaction information 412 which may include the merchant's identity, the user's identity and an indication of which accounts are to be used.

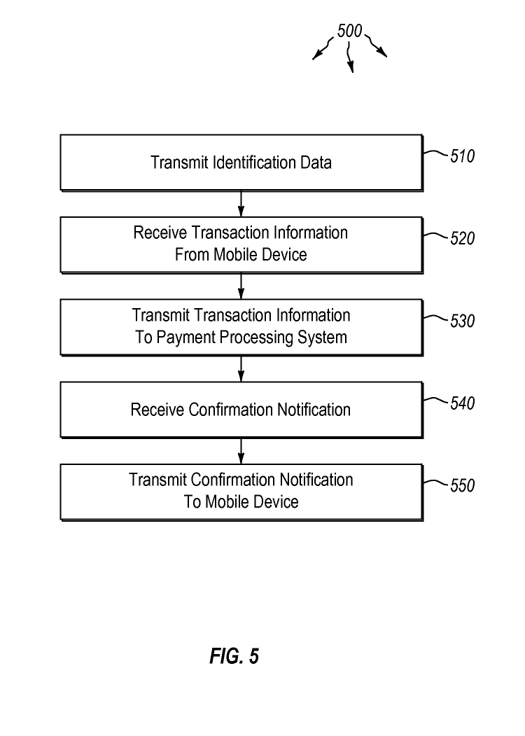

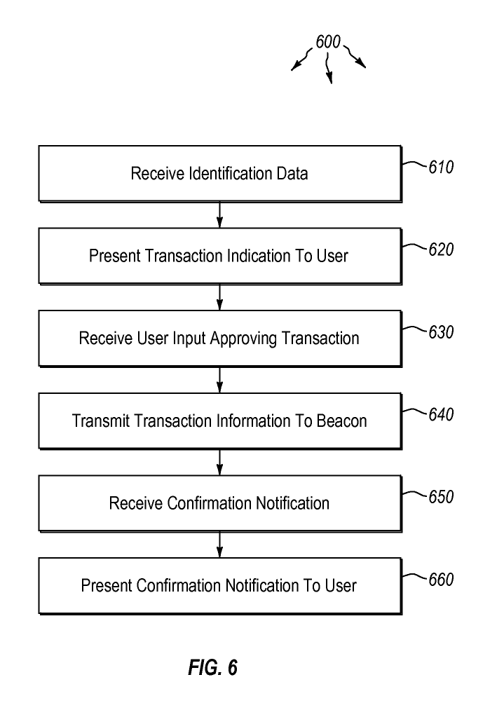

This transaction information 412 may be sent by transmitter 406 of the communications module 414 to beacon 413. As mentioned above, the beacon 413 may be a standalone device, or may be embedded within a point of sale device (e.g. POS device 414). The beacon 413 may send the transaction information to the point of sale device 414 and/or to a payment processing service 416 (or payment services 400 of FIG. 1). The POS and/or the payment processing service 416 may, alone or in tandem, process the transaction, and may send a confirmation notice 417 to the beacon which relays the confirmation notice on to the computer system 401 and thus to the user 410. In this manner, a beacon may be used to process transactions in a secure manner, without having to retrofit the merchant with new POS devices. The beacon may allow users to connect wirelessly within (or near) a store and conduct transactions using a cloud-based payment service without requiring new POS devices at the store. These concepts will be explained further below with regard to methods 500 and 600 of FIGS. 5 and 6, respectively.

In view of the systems and architectures described above, methodologies that may be implemented in accordance with the disclosed subject matter will be better appreciated with reference to the flow charts of FIGS. 5 and 6. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 illustrates a flowchart of a method 500 for conducting a monetary transaction using a beacon. The method 500 will now be described with frequent reference to the components and data of environment 400 of FIG. 4.

Method 500 includes transmitting identification data from the beacon indicating the relative location of the beacon and further indicating that the beacon is associated with a specified entity (510). For example, beacon 413 may transmit identification data 418 to computer system 401, among other mobile computing systems. The beacon 413 may be a standalone device (as shown in FIG. 4) or may be part of a POS device (as shown in FIG. 2). The POS device 414 shown in FIG. 4 may include a processor and potentially an embedded beacon or at least a connection to a beacon. The beacon 413 may be configured to receive data from and transmit data to mobile computing systems within its transfer radius. The POS device 414 may further include a payment coordinating module (module 260 as shown in FIG. 2) which is configured to work with and/or control the beacon to conduct payments between parties. In some embodiments, the payment coordinating module implements the beacon to perform the steps 510-550 of FIG. 5.

Method 500 next includes receiving transaction information from a mobile device including information identifying a customer and a payment amount (520). The beacon 413 may receive transaction information 412 from computing system 401 which may be a mobile device. The transaction information may include information that identifies a customer (e.g. user 410) and a payment amount. The payment amount may be associated with a purchase of goods or services, an entrance fee for an even or venue, a money transfer between individuals or any other type of monetary transaction.

Method 500 further includes transmitting the received transaction information to a payment processing system (530), receiving an indication from the payment processing system that the payment was processed (540), and transmitting a confirmation notification to the mobile device indicating that the transaction was processed (550). Thus, the beacon 413 may transmit the transaction information 412 received from the computer system 401 to the payment processing service and/or the point of sale device 414. In some cases, a direct wireless or wired communication link 415 exists between the POS device 414 and the payment processing service 416. The payment processing service may be a distributed, cloud-based payment processing service capable of processing transactions between parties once the service is aware of the parties' identities and the amount of money that is to be transferred. Once the payment has been processed, the beacon may receive a confirmation notification 417 (assuming the payment went through—otherwise a failure notification may be transferred in its place) from the payment processing service 416. The beacon 413 may then transmit that confirmation notification 417 on to the computing system 401 where it can be viewed by the user 410.

In some embodiments where the beacon 413 is embedded within the POS device 414, the confirmation notification 417 sent to the mobile device 401 may be transmitted directly by the POS device 414. Similarly, in cases where the beacon 413 is embedded within the POS device 414, the transaction information 412 initiated from the mobile device 401 may be received directly from the mobile device. The transaction information 412 received from the mobile device may include a transaction sequence number, a mobile device unique identifier, and/or a token. The confirmation notification 417 from the payment processing system 416 indicating that the payment was processed may also include a transaction sequence number, a mobile device unique identifier, and/or a token. The payment coordinating module 260 of FIG. 2 may be configured to compare the transaction sequence number, the mobile device unique identifier, and/or the token received from the mobile device to the transaction sequence number, mobile device unique identifier and/or token received from the payment processing system 416. If the transaction sequence number, mobile device unique ID and/or token match, then the transaction is permitted to continue. Otherwise, the transaction is terminated and a warning or failure notice is generated.

As mentioned above, the beacon 413 may include or implement a variety of different wireless technologies including WiFi, WiFi-Direct (i.e. WiFi P2P), Bluetooth, Bluetooth Low Energy (BLE) or other wireless standards used to connect electronic devices. In cases where the beacon 413 is a Bluetooth beacon, the Bluetooth beacon may communicate with the mobile device 401 and any other surrounding mobile devices using the Bluetooth wireless communication standard. The identification data from the beacon may indicate the relative location of the beacon or may provide a more accurate indication of location including GPS coordinates. The identification data sent out by the beacon may also indicate that the beacon is associated with a specified entity or venue. The identification may include a proximity key that is associated with the specified entity. The proximity key positively identifies the location and/or owner of the beacon, thereby allowing the user to trust that beacon indeed belongs to the merchant, and that any transactions conducted with that merchant will be valid.

In some embodiments, a user may be able to prepay one or more of the items he or she wishes to purchase. For example, when a user is standing in line or is elsewhere in the store, the beacon may transmit the information related to the item and its purchase to the user's electronic device. The user may then be able to prepay for the selected one or more items while standing in line or while being elsewhere in the store. The transaction may be carried out over the beacon, as described in Method 500 of FIG. 5. In this manner, a user may conduct a transaction using the beacon to prepay for any items in the store, regardless of the user's location in the store. In some cases, the user may gather multiple items that he or she wishes to purchase. These items may be stored in a list of items or in a virtual shopping cart (as well as potentially in a physical shopping cart). When checking out, the beacon may indicate to a store employee that the user has already paid for the item(s) in the virtual (and/or physical) shopping cart and may allow the user to proceed out of the store with their paid items.

Turning now to FIG. 6, a flowchart is illustrated of a method 600 for conducting a monetary transaction using a beacon. The method 600 will now be described with frequent reference to the components and data of environment 400 of FIG. 4.

Method 600 includes receiving identification data from a beacon indicating the relative location of the beacon and an indication of association with a specified entity (610). For example, receiver 405 of communications module 404 in computing system 401 may receive identification data 418 from beacon 413 indicating the relative location of the beacon and an indication of the beacon's association with a specified entity such as a store, a chain of stores, a location, an event or venue. The beacon may have received transaction information 412 initiating a transaction between user 410 and a merchant. In response, the beacon may initiate the transaction using the payment processing service 416. The payment processing service may send a notification to the user 410 through the beacon asking confirmation of the transaction. Alternatively, the indication generating module 407 may generate a transaction indication 408 prior to sending the transaction information 412 and ask for the user's permission up front. Either way, the user 410 is made aware of the pending transaction.

Method 600 thus includes presenting a transaction indication 408 to a user indicating that a transaction is being conducted with the entity (620). Method 600 further includes receiving input from the user 410 indicating that the transaction is to be completed (630), and transmitting one or more portions of transaction information to the beacon, where the beacon is configured to transmit the transaction information to the point of sale (POS) device and/or the payment processing service (640). The user 410 may thus provide input 411 indicating that the transaction is approved from their perspective, and that the transaction details can be transmitted. The transmitter 406 of the communications module 404 may thus transmit the transaction details in transaction information 412. The beacon 413 may transmit the transaction information on to the payment processing service 416, and subsequently receive a confirmation notification. This confirmation notification may be transmitted by the beacon 413 where it is received at the mobile computing system 401, indicating that the transaction was processed (650). The confirmation notification 417 may then be presented to the user on the mobile device (660).

In some cases, the confirmation notification may include a transaction receipt listing the goods or services that were purchased during the transaction. In cases where the user has used the mobile computing system 401 to conduct transactions with the merchant in the past, the mobile computing system 401 may automatically recognize the beacon 413 on subsequent visits to the location of the beacon. This may allow the beacon/POS device to recognize the user and give the user rewards for their loyalty. The rewards may include coupons, loyalty points or other types of offers or rewards. These rewards may be applied to the item, service or entry fee to be paid for using the transaction, allowing the transaction to be discounted for returning customers. Indeed, the payment processing service 416 may be configured to apply coupons, rewards or loyalty points to the transaction upon identifying the user 410 associated with the mobile computing system 401.

The payment processing service 416 may be a cloud-based payment processing service configured to process payments between entities. The cloud-based payment processing service may work together with the point of sale device 414 (e.g. using communications link 415) to process transactions between entities. In some cases, where the POS device has sufficient information or access to bank or credit accounts, the POS device itself may process the payment between the user 410 and the entity. When a transaction is conducted between parties, the transaction indication 408 presented to the user 410 indicating that a transaction is being conducted with the entity may include interactive buttons allowing the user to allow or prevent the transaction from being completed. Thus, the transaction indication 408 may include not only information about the transaction that is pending, by may also include interactive UI elements that permit the user to allow or deny processing of the transaction. Once the user has approved the transaction, it may be processed between the entity and the user without input from a point of sale attendant, and without the merchant needing to upgrade their POS devices.

Accordingly, methods, systems and computer program products are provided which conduct monetary transactions using a beacon. The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A point of sale (POS) device comprising:
a processor;
a beacon configured to receive data from and transmit data to one or more mobile computing systems; and
a payment coordinating module configured to implement the beacon to perform the following:
transmit identification data from the beacon indicating the relative location of the beacon and further indicating that the beacon is associated with a specified entity;
receive transaction information from a mobile device including information identifying a customer and a payment amount;
transmit the received transaction information to a payment processing system;
receive an indication from the payment processing system that the payment was processed; and
transmit a confirmation notification to the mobile device indicating that the transaction was processed.

2. The POS device of claim 1, wherein the confirmation notification sent to the mobile device is transmitted directly by the POS device.

3. The POS device of claim 1, wherein the transaction information initiated from a mobile device is received directly from the mobile device.

4. The POS device of claim 3, wherein the transaction information received from the mobile device includes at least one of a transaction sequence number, a mobile device unique identifier and a token.

5. The POS device of claim 4, wherein the confirmation notification from the payment processing system indicating that the payment was processed includes at least one of a transaction sequence number, a mobile device unique identifier, and a token.

6. The POS device of claim 5, wherein the payment coordinating module compares at least one of the transaction sequence number, the mobile device unique identifier, and token received from the mobile device to at least one of the transaction sequence number, mobile device unique identifier and token received from the payment processing system.

7. The POS device of claim 1, where the beacon comprises a Bluetooth beacon.

8. The POS device of claim 7, wherein the Bluetooth beacon communicates with the one or more mobile devices using the Bluetooth wireless communication standard.

9. The POS device of claim 1, wherein the identification data from the beacon indicating the relative location of the beacon and further indicating that the beacon is associated with a specified entity comprises a proximity key that is associated with the specified entity.

10. A method, implemented at a computer system that includes at least one processor, for conducting a monetary transaction using a beacon, the method comprising:
receiving, at a hardware receiver, identification data from a beacon indicating the relative location of the beacon and an indication of association with a specified entity;
presenting a transaction indication to a user indicating that a transaction is being conducted with the entity;
receiving input from the user indicating that the transaction is to be completed;
transmitting, by a hardware transmitter, one or more portions of transaction information to the beacon, the beacon being configured to transmit the transaction information to at least one of a point of sale (POS) device or a payment processing service associated with the specified entity; and
receiving a confirmation notification indicating that the transaction was processed.

11. The method of claim 10, further comprising presenting the confirmation notification to the user on a display of the mobile device.

12. The method of claim 10, wherein the confirmation notification includes a transaction receipt listing the goods or services that were purchased during the transaction.

13. The method of claim 10, wherein the beacon comprises a Bluetooth low energy (BLE) beacon.

14. The method of claim 10, wherein the beacon is automatically recognized by the mobile device upon subsequent visits to the location of the beacon, allowing transactions to be discounted for returning customers.

15. The method of claim 10, wherein the payment processing service applies coupons, rewards or loyalty points to the transaction upon identifying a user associated with the mobile device.

16. A computer program product for implementing a method for conducting a monetary transaction using a beacon, the computer program product comprising one or more computer-readable storage media having stored thereon computer-executable instructions that, when executed by one or more processors of a computing system, cause the computing system to perform the method, the method comprising:
receiving data from a beacon indicating the relative location of the beacon and an indication of association with a specified entity;
presenting a transaction indication to a user indicating that a transaction is being conducted with the entity;
receiving input from the user indicating that the transaction is to be completed;
transmitting one or more portions of transaction information to the beacon, the beacon being configured to transmit the transaction information to at least one of a point of sale (POS) device or a payment processing service;
receiving a confirmation notification indicating that the transaction was processed; and
presenting the confirmation notification to the user.

17. The computer program product of claim 16, wherein the payment processing service comprises a cloud-based payment processing service configured to process payments between entities.

18. The computer program product of claim 16, wherein the POS device processes the payment between the user and the entity.

19. The computer program product of claim 16, wherein the transaction indication presented to the user indicates that a transaction is being conducted with the entity comprises one or more interactive buttons allowing the user to allow or prevent the transaction from being completed.

20. The computer program product of claim 16, wherein the transaction is processed between the entity and the user without input from a point of sale attendant.
